(19) United States
(12) Patent Application Publication
(10) Pub. No.: US 2013/0241225 A1
(43) Pub. Date: Sep. 19, 2013

(54) VACUUM PICKUP DEVICE AND METHOD FOR PICKUP

(71) Applicants: Minghu QI, Shenzhen (CN); Chun Hao Wu, Shenzhen (CN); Kun Hsien Lin, Shenzhen (CN); Yongqiang Wang, Shenzhen (CN); Zenghong Chen, Shenzhen (CN); Weibing Yang, Shenzhen (CN)

(72) Inventors: Minghu QI, Shenzhen (CN); Chun Hao Wu, Shenzhen (CN); Kun Hsien Lin, Shenzhen (CN); Yongqiang Wang, Shenzhen (CN); Zenghong Chen, Shenzhen (CN); Weibing Yang, Shenzhen (CN)

(73) Assignee: SHENZHEN CHINA STAR OPTOELECTRONICS TECHNOLOGY CO. LTD., Shenzhen (CN)

(21) Appl. No.: 13/510,293

(22) PCT Filed: Apr. 6, 2012
(86) PCT No.: PCT/CN12/73563

§ 371 Date: May 17, 2012

(30) Foreign Application Priority Data
Mar. 15, 2012 (CN) 201210068808.4

(51) Int. Cl. B25J 15/06

(52) U.S. Cl. 294/186

(57) ABSTRACT

The present invention further provides a vacuum pickup device for manufacturing process of a flat panel and which comprises a detecting unit and a first vacuum circuit and a second vacuum circuit independent from each other. The first vacuum circuit is interconnected with a first nozzle, a first vacuum tube and a first vacuum reservoir in serial. The second vacuum circuit is interconnected with a second nozzle, a second vacuum tube and a second vacuum reservoir in serial. A joint sucking area is defined by the first and second nozzles jointly, and the detecting unit is used to monitor an operation status of the first and second vacuum circuits. Wherein either one of the first and second vacuum circuits is detected as a normal operational status, then the sucking process will remain in operation; and wherein when either the first vacuum circuit or the second vacuum circuit is detected as an abnormal status, the sucking process is halted. The present invention further provides a method for performing the vacuum pickup device.

### FIELD OF THE INVENTION

The present invention relates to a technology of industrial apparatus, and more particularly to a vacuum pickup apparatus and a method for picking up a glass substrate.

### DESCRIPTION OF PRIOR ART

During the manufacturing processes of an flat panel, a glass substrate used for the flat panel has to undergo a plurality of working following processes, such as a cleaning, a masking processes of photo resist, a developing process, and an exposure process etc. before it is completed. In order to provide a quality-proved and cost-efficient production, automation has to be implemented so as to control, deliver or displace the positions of the glass substrate in each workstation. Specially, when the glass substrate is needed to be displaced from one workstation to another workstation, a vacuum pickup device has to be implemented so as to carry the glass substrate from one workstation to the other workstation.

Picking up with vacuum means placing a nozzle onto the glass substrate and then provides a vacuum or negative air pressure such that the glass substrate is securely held by the nozzle. FIG. 1 illustrates an existing vacuum device and its configuration. As shown, it generally includes a tube 101, a displacing arm 102, a plurality of nozzles 103, and a vacuum reservoir (not shown in this Figure). A vacuumed circuit is established through the tube 101, the displacing arm 102 and the plurality of nozzles 103. However, after a period of working cycles, the nozzle tends to be worn out or damaged. In addition, a fluctuation of vacuum may also experience resulted from some unexpected malfunction. In this case, the vacuum in the circuit can not be sustained and the glass substrate may easily dropped therefrom and cause damages. On the other hand, when a fluctuation of vacuum is experienced within the circuit, even the nozzles may still get hold of the glass substrate, the fluctuation of the vacuum within the circuit may still trigger an alarm so as to stop the production line when insufficient vacuum is detected. The maintenance personnel have to conduct a check and examination so as to overcome the issue. Nevertheless, it may still a case of finding nothing as the vacuum resumes. This is really annoying as not only will it halt the operation, but will also exhaust manpower in fault-finding.

Since there is only one vacuum circuit, once an abnormal situation is encountered, the operation will be halted. This creates a great frustration to the production line.

### SUMMARY OF THE INVENTION

The key issue the present invention intends to address is to provide a technology of vacuum pickup device and a method thereof, and which can effectively reduce the damages caused by malfunctions resulted from loss of vacuum. As a result, the overall production efficiency is increased.

In order to resolve the above-described issue in the field, a vacuum pickup device for manufacturing process of a flat panel is provided. The vacuum pickup device comprises a displacing arm, a detecting unit, a pressure displaying unit, an alarming unit, and first and second vacuum circuits independent to each other. The first vacuum circuit is interconnected with a first nozzle, a first vacuum tube and a first vacuum reservoir in serial. The second vacuum circuit is interconnected with a second nozzle, a second vacuum tube and a second vacuum reservoir in serial. The first and second nozzles are arranged on the displacing arm and the pressure displaying unit and the alarming unit being interconnected to the detecting unit. A joint sucking area is defined by the first and second nozzles jointly, and the detecting unit is used to monitor an operation status of the first and second vacuum circuits. Wherein either one of the first and second vacuum circuits is detected as a normal operational status, then the sucking process will remain in operation. Wherein when either the first vacuum circuit or the second vacuum circuit is detected as an abnormal status, the sucking process is halted; and wherein the pressure displaying unit displays the values detected from the first and second vacuum circuits, an alarm will be triggered by the alarming unit when at least one of the first and second vacuum circuits is detected as abnormal.

According to one preferred embodiment of the present invention, wherein the pressure displaying device is a vacuum meter.

According to one preferred embodiment of the present invention, wherein the alarming unit is a warning light or buzzer.

According to one preferred embodiment of the present invention, wherein the alarming unit detects a malfunction or abnormal status on both the first and second vacuum circuits, an alarm showing both of the first and second vacuum circuits will be triggered, the sucking operation will be halted accordingly; while when only one of the first and second vacuum circuits is detected for abnormal, then a corresponding alarm will be triggered showing the malfunctioned vacuum circuit.

In order to resolve the above-described issue, the present invention further provides a vacuum pickup device for manufacturing process of a flat panel and which comprises a detecting unit and a first vacuum circuit and a second vacuum circuit independent from each other. The first vacuum circuit is interconnected with a first nozzle, a first vacuum tube and a first vacuum reservoir in serial. The second vacuum circuit is interconnected with a second nozzle, a second vacuum tube and a second vacuum reservoir in serial. A joint sucking area is defined by the first and second nozzles jointly, and the detecting unit is used to monitor an operation status of the first and second vacuum circuits. Wherein either one of the first and second vacuum circuits is detected as a normal operational status, then the sucking process will remain in operation; and wherein when either the first vacuum circuit or the second vacuum circuit is detected as an abnormal status, the sucking process is halted.

According to another preferred embodiment, wherein the vacuum pickup device includes a pressure displaying unit which is interconnected to the detecting unit and displays the values detected from the first and second vacuum circuits.

Still according to the preferred embodiment of the present invention, wherein the pressure displaying device is a vacuum meter.

According to the preferred embodiment of the present invention, characterized in that the pickup device includes an alarming device interconnected to the detecting unit, and wherein an alarm will be triggered when either one of the first and second vacuum circuits is detected as a abnormal operational status.

According to the preferred embodiment of the present invention, wherein the alarming unit detects a malfunction or abnormal status on both the first and second vacuum circuits, an alarm showing both of the first and second vacuum circuits will be triggered, the sucking operation will be halted accordingly; while when only one of the first and second vacuum circuits is detected for abnormal, then a corresponding alarm will be triggered showing the malfunctioned vacuum circuit.

According to the preferred embodiment of the present invention, wherein the alarming unit is a warning light or buzzer.

Still according to the preferred embodiment, wherein the vacuum pickup device includes a displacing arm on which the first and second nozzles are mounted thereon.

Still in order to resolve the above-described technical issue, the present invention provides a method for vacuum picking up, characterized in that the method includes a first step of vacuuming a first vacuum circuit having a first nozzle and a second vacuuming circuit having a second nozzle independent to each other such that both first and second vacuum circuits are in vacuumed states so as to perform a pickup operation. A second step of monitoring the pickup operational status performed by the first and second vacuum circuits. And a third step of keeping on the pickup operation when at least one of the first and second vacuum circuits is normal, and halting the pickup operation when an abnormal status is detected on each of the first and second vacuum circuits.

According to one preferred embodiment of the method made in accordance with the present invention, wherein after the step of halting the pickup operation when an abnormal status is detected on each of the first and second vacuum circuits, a step of triggering an alarm is performed so as to stop the pickup operation.

Still according to one preferred embodiment of the method made in accordance with the present invention, wherein after the step of keeping on the pickup operation when at least one of the first and second vacuum circuits is normal, the pickup operation further includes the step of keeping on pickup operation when both of the first and second vacuum circuits are detected a normal status, and keeping on pickup operation when at least one of the first and second vacuum circuits is detected abnormal, while triggering an alarm indicating the corresponding first or second vacuum circuit is abnormal.

In conclusion, since the vacuum pickup device and its method utilize a dual-circuit arrangement in pickup up operation, the overall system can keep on the pickup operation even one of the circuits is detected abnormal. The system is halted and stopped only when both of the circuits are detected abnormal. As a result, the maintenance and defective rate can be reduced, while the yield can be increased as the maintenance is shortened.

The above-described are merely some certain type of embodiments of the present invention, and in order to readily and explanatorily describe the above and other purposes, features and advantages, a set of drawings along with detailed description is given below.

### BRIEF DESCRIPTION OF DRAWINGS

FIG. 1 is an illustration of a configuration of prior art vacuum pickup device;

FIG. 2 is an illustration of the working principle of a first embodiment of a vacuum pickup device made in accordance with the present invention;

FIG. 3 is a configuration of a vacuum pickup device shown in FIG. 2;

FIG. 4 is an illustration of the working principle of a second embodiment of a vacuum pickup device made in accordance with the present invention; and

FIG. 5 is a flow diagram of a method showing how the vacuum pickup device of the second embodiment operates.

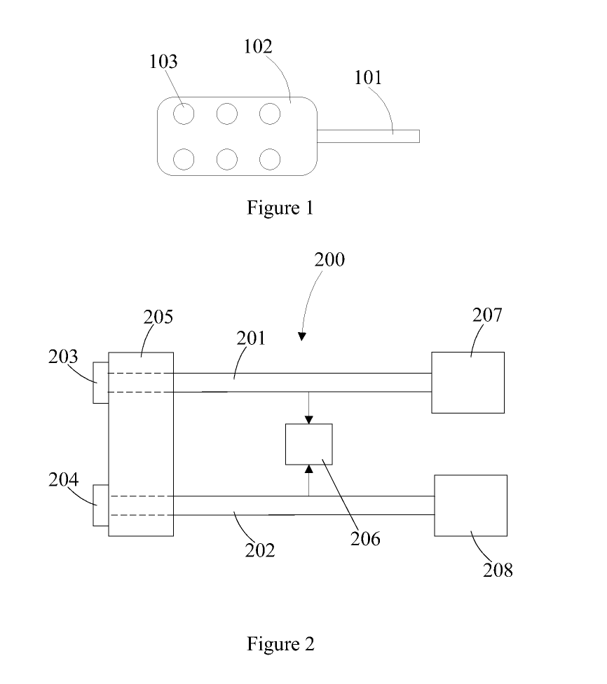

### DETAILED DESCRIPTION OF PREFERRED EMBODIMENTS

The intended purposes and advantages of the present invention can be readily understood by the help of the following descriptions as well as accompanied drawings. It is believed that with the detailed description given below, the purposes and advantages are self-explanatory and evident. It should be noted that the description is merely for illustration while is not intended for limitation.

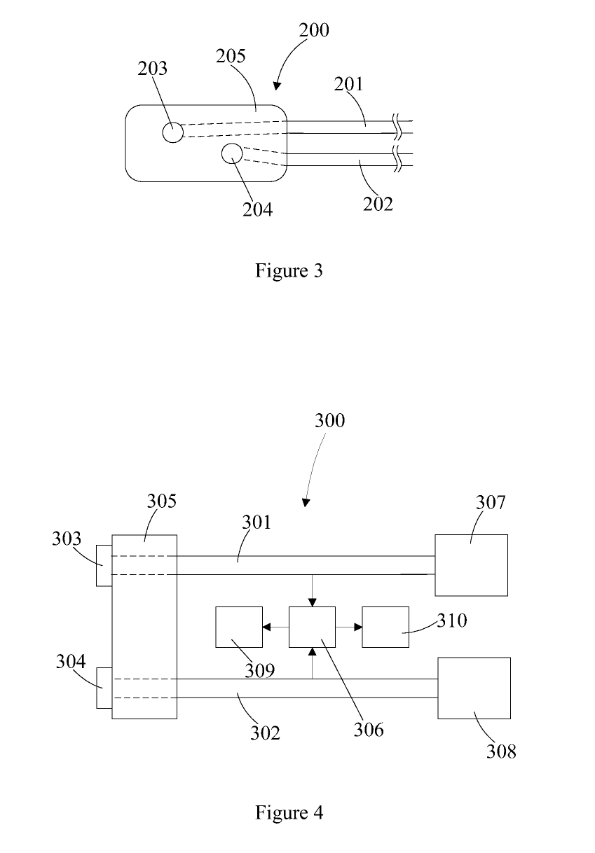

Referring to FIG. 2, which is an illustration of the working principle of a first embodiment of a vacuum pickup device made in accordance with the present invention; and FIG. 3, which is a configuration of a vacuum pickup device shown in FIG. 2. The vacuum pickup device 200 is capable of being used in the production of the flat panel, specially it can be used to handle the glass substrate during the production. The vacuum pickup device 200 includes a detecting unit 206, and first and second vacuum circuits (not shown). The first vacuum circuit includes a first vacuum nozzle 203, a first vacuum tube 201, and a first vacuum reservoir 207. The second vacuum circuit includes a second vacuum nozzle 204, a second vacuum tube 202, and a second vacuum reservoir 208. A joint sucking area (not labeled) is defined by the first vacuum nozzle 203 and a second vacuum nozzle 204. Both the first vacuum nozzle 203 and the second vacuum nozzle 204 can create a vacuumed status. The detecting unit 206 can be used to monitor the working status of the first vacuum circuit and a second vacuum circuit.

In this embodiment, the quantity of the first vacuum nozzle 203 and the second vacuum nozzle 204 in this embodiment is one. Of course, the number can be increased according to field requirements. The arrangement can be diversely, such as offset from each other, and in-line with each other. Their positions and arrangements are prioritized for the convenience, efficiency of solo operation of each of the first vacuum nozzle 203 of the second vacuum nozzle 204.

The vacuum pickup device 200 further includes a displacing arm 205 on which the first vacuum 203 and the second vacuum nozzle 204 are installed. The production of the glass substrate needs a plurality of working stations in which working environmental is varied and changed. As a result, the working position of the vacuum pickup device 200 is not fixed, which is moved according to the working position of the glass substrate which could be disposed in a horizontal position, or be erected in a vertical position. In some certain working position, it could be placed in a tilted position. Accordingly, the displacing arm 205 is moveable. Because of the movement of the displacing arm 205, the sucking area defined by the first vacuum nozzle 203 and the second vacuum nozzle 204 can be placed on different area of the glass substrate so as to pickup the glass substrate for different working processes. In this embodiment, the vacuum pickup device 200 can be solely used to a vehicle for carrying the glass substrate. It can also be served as a working arm of an industrial robot.

Please referring to FIG. 4, which is an illustration of the working principle of a second embodiment of a vacuum pickup device made in accordance with the present invention. The vacuum pickup device 300 is configured with the basic configuration of the first embodiment, and further included with a pressure displaying unit 309, and an alarming unit 301 both interconnected to a detecting unit 306. Substantially, the vacuum pickup device 300 is configured with the detecting unit 306 and first and second vacuum circuits (not shown). The first vacuum circuit includes a first vacuum nozzle 303, a first vacuum tube 301, and a first vacuum reservoir 307. The second vacuum circuit includes a second vacuum nozzle 304, a first vacuum tube 302, and a first vacuum reservoir 308. A joint sucking area (not labeled) is defined by the first vacuum nozzle 303 and the second vacuum nozzle 304. The detecting unit 306 is used to detect the working status of the first and second vacuum circuits.

The pressure displaying unit 309 can display the measured values from the first and second vacuum circuits. With the implementation of the pressure displaying unit 309, the instant working status of the vacuum pickup device 300 can be readily indicated. As a result, when there is an abnormal status within the vacuum pickup device 300, it can be instantly detected and addressed by the appropriate maintenance and repairs by qualified personnel. In this embodiment, the pressure displaying unit 309 is a vacuum meter. When one of the first and second vacuum circuits is detected by the detecting unit 306, the alarming unit 310 will trigger an alarm or warning such that the appropriate measurements can be taken timely and immediately. In this embodiment, the alarming unit 310 is a warning light or a buzzer. It can be readily appreciated that the alarming unit 310 can be other equipment having a function of indicating status.

During the operation of the vacuum pickup device, the first vacuum nozzle 303 and the second vacuum nozzle 305 are brought in contact with the glass substrate by the displacement of the displacing arm 305. The first vacuum reservoir 307 and the second vacuum reservoir 308 will then provide a vacuum thereto. As a result, the sucking area defined by the first vacuum nozzle 303 and the second vacuum nozzle 304 starts to get hold of the glass substrate. During the operation, the detecting unit 306 will monitor the working pressure of the first vacuum circuit and the second vacuum circuit, and the pressure displaying unit 309 will display the measured vacuum values within the first vacuum tube 301 and the second vacuum tube 302. When a first measured vacuum value from one of the first and second vacuum circuits is below a preset working value, the vacuum pickup device 300 is still allowed to keep on operating. Once a second measured vacuum value, which is lower than the preset vacuum value is detected from the other of the first and second vacuum circuits, the alarming unit 310 will trigger an alarm indicating there is a malfunction. On the other hand, when the measured value from both of the first and second vacuum circuits are lower than the preset value, the vacuum pickup device will be halted immediately. Meanwhile, the alarming unit 310 will also trigger an alarm indicating both of the circuits are now malfunctioned. The operation will therefore be stopped.

It should be noted that in the actual production, when the detecting unit 306 sensed an abnormal status of the first vacuum circuit and the second vacuum circuit, the alarming unit 310 will trigger an alarm in responsive to the detected abnormal status. However, in this situation, if the alarming unit 310 keeps on lighting up the warning light or triggering the buzzer, this will create a psychological impact to the production. Accordingly, the alarming unit 310 can be modified such that the warning light or buzzer will be set off intermittently, and eventually completely stops after a certain preset number is reached. Alternatively, a displaying panel can be used to indicate the abnormal situation. This visual alarming will still reach the same result, while the production will not be affected.

In this case, once one of the vacuum circuits of the vacuum pickup device 300 is malfunctioned, the vacuum pickup device can keep on working with the other vacuum circuit. As a result, the glass substrate will not be dropped, while a warning or alarm can be triggered both visually or auditory. As such, the maintenance personnel can immediately conduct a necessary treatment so as to overcome the malfunctions when the vacuum pickup device 300 is not operated under high speed. This arrangement can readily increase the operational stability of the vacuum pickup device 300. A complete halt of the production line is therefore avoided.

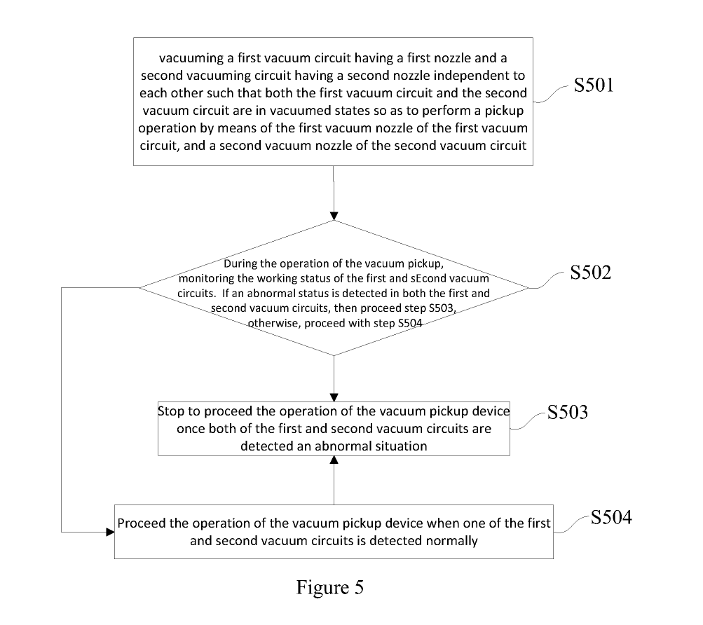

Referring to FIGS. 4 and 5, the working procedures of a method for vacuum pickup are illustrated.

Step S501: vacuuming a first vacuum circuit having a first nozzle and a second vacuuming circuit having a second nozzle independent to each other such that both the first vacuum circuit 301 and the second vacuum circuit 302 are in vacuumed states so as to perform a pickup operation by means of the first vacuum nozzle 303 of the first vacuum circuit, and a second vacuum nozzle 303 of the second vacuum circuit.

The first vacuum circuit and the second vacuum circuit are independently arranged from each other, and will not be affected by each other. Each of the first and second vacuum circuits can work independently to operate normally. That is to say, the sucking power from either one of the first and second vacuum circuits is strong enough to get hold of the glass substrate. The first vacuum nozzle 303 and the second vacuum nozzle 304 are brought to in contact with the glass substrate by the displacing arm 305. Then the first and second vacuum reservoirs 307, 308 are brought to the first vacuum nozzle 303 and the second vacuum nozzle 304 such that a negative pressure is created in both of the first vacuum tube 301 and the second vacuum tube 302. By the differential created between the nozzles and the atmosphere, the glass substrate is getting hold by the first and second vacuum nozzles 303 and 304.

Step S502: during the operation of the vacuum pickup, monitoring the working status of the first and second vacuum circuits. If an abnormal status is detected in both the first and second vacuum circuits, then proceed step S503, otherwise, proceed with step S504.

The working status of both the first and second vacuum circuits are monitored independently for their operational parameters so as to determine whether its working status is normal or not. If an abnormal situation is detected, the vacuum circuit will fail to provide necessary vacuum for the vacuum pickup device. In this embodiment, the working status of the first and second vacuum circuits can be detected by measuring the vacuum value therein.

Step S503: Stop to proceed the operation of the vacuum pickup device once both of the first and second vacuum circuits are detected an abnormal situation.

Right on or after the operation of the vacuum pickup device is stopped, an alarm indicating the failure of both of the first and second vacuum circuit is triggered. In addition, an indication of stopping the operation is given.

Step S504: Proceed the operation of the vacuum pickup device when one of the first and second vacuum circuits is detected normally.

When one of the first and second vacuum circuits is detected as normal, then the operation of the vacuum pickup device will proceed. Once one of the first and second vacuum circuits is detected, the operation of the vacuum pickup device keeps on working, while an alarming will be triggered to indicate the malfunction.

In this embodiment, the alarm can be a warning light, a buzzer or a displaying panel.

By provision of the vacuum pickup device described above, a dual-vacuum-circuit is provided to ensure a safe and reliable operation of pickup of the glass substrate. Even one of the vacuum circuits is malfunctioned, the overall system is still workable with the functioning of the other vacuum circuit. The system will only be halted when both of the vacuum circuits are detected malfunctioned. Accordingly, the damages as well as maintenance can be effectively reduced, while the yield can be increased.

The description above is merely some preferable embodiments of the present invention, while is not intended to limit the implementation of the present invention. Any alternation and/or modifications based on the descriptions and drawings are to be construed as equivalent under the spirit of the present invention, and should be covered by the claims set forth below. On the other hand, even direct and indirect implementation of the present invention to other technology field, should still be covered by the claims as set forth below

1. A vacuum pickup device for manufacturing process of a flat panel, characterized in that the vacuum pickup device comprises:
a displacing arm, a detecting unit, a pressure displaying unit, an alarming unit, and first and second vacuum circuits independent to each other;
the first vacuum circuit interconnecting with a first nozzle, a first vacuum tube and a first vacuum reservoir in serial;
the second vacuum circuit interconnecting with a second nozzle, a second vacuum tube and a second vacuum reservoir in serial;
the first and second nozzles being arranged on the displacing arm and the pressure displaying unit and the alarming unit being interconnected to the detecting unit;
a joint sucking area being defined by the first and second nozzles jointly, and the detecting unit being used to monitor an operation status of the first and second vacuum circuits, wherein either one of the first and second vacuum circuits is detected as a normal operational status, then the sucking process will remain in operation; wherein when either the first vacuum circuit or the second vacuum circuit is detected as an abnormal status, the sucking process is halted; and
wherein the pressure displaying unit displays the values detected from the first and second vacuum circuits, an alarm will be triggered by the alarming unit when at least one of the first and second vacuum circuits is detected as abnormal.

2. The vacuum pickup device as recited in claim 1, wherein the pressure displaying device is a vacuum meter.

3. The vacuum pickup device as recited in claim 1, wherein the alarming unit is a warning light or buzzer.

4. The vacuum pickup device as recited in claim 1, wherein the alarming unit detects a malfunction or abnormal status on both the first and second vacuum circuits, an alarm showing both of the first and second vacuum circuits will be triggered, the sucking operation will be halted accordingly; while when only one of the first and second vacuum circuits is detected for abnormal, then a corresponding alarm will be triggered showing the malfunctioned vacuum circuit.

5. A vacuum pickup device for manufacturing process of a flat panel, characterized in that the vacuum pickup device comprises:
a detecting unit and a first vacuum circuit and a second vacuum circuit independent from each other;
the first vacuum circuit interconnecting with a first nozzle, a first vacuum tube and a first vacuum reservoir in serial;
the second vacuum circuit interconnecting with a second nozzle, a second vacuum tube and a second vacuum reservoir in serial;
a joint sucking area being defined by the first and second nozzles jointly, and the detecting unit being used to monitor an operation status of the first and second vacuum circuits;
wherein either one of the first and second vacuum circuits is detected as a normal operational status, then the sucking process will remain in operation; wherein when either the first vacuum circuit or the second vacuum circuit is detected as an abnormal status, the sucking process is halted.

6. The vacuum pickup device as recited in claim 6, wherein the vacuum pickup device includes a pressure displaying unit which is interconnected to the detecting unit and displays the values detected from the first and second vacuum circuits.

7. The vacuum pickup device as recited in claim 6, wherein the pressure displaying device is a vacuum meter.

8. The vacuum pickup device as recited in claim 5, characterized in that the pickup device includes an alarming device interconnected to the detecting unit, and wherein an alarm will be triggered when either one of the first and second vacuum circuits is detected as a abnormal operational status.

9. The vacuum pickup device as recited in claim 8, wherein the alarming unit detects a malfunction or abnormal status on both the first and second vacuum circuits, an alarm showing both of the first and second vacuum circuits will be triggered, the sucking operation will be halted accordingly; while when only one of the first and second vacuum circuits is detected for abnormal, then a corresponding alarm will be triggered showing the malfunctioned vacuum circuit.

10. The vacuum pickup device as recited in claim 8, wherein the alarming unit is a warning light or buzzer.

11. The vacuum pickup device as recited in claim 5, wherein the vacuum pickup device includes a displacing arm on which the first and second nozzles are mounted thereon.

12. A method for vacuum picking up, characterized in that the method includes the steps of:
vacuuming a first vacuum circuit having a first nozzle and a second vacuuming circuit having a second nozzle independent to each other such that both first and second vacuum circuits are in vacuumed states so as to perform a pickup operation;
monitoring the pickup operational status performed by the first and second vacuum circuits; and
keeping on the pickup operation when at least one of the first and second vacuum circuits is normal, and halting the pickup operation when an abnormal status is detected on each of the first and second vacuum circuits.

13. The method as recited in claim 12, wherein after the step of halting the pickup operation when an abnormal status is detected on each of the first and second vacuum circuits, a step of triggering an alarm is performed so as to stop the pickup operation.

14. The method as recited in claim 12, wherein after the step of keeping on the pickup operation when at least one of the first and second vacuum circuits is normal, the pickup operation further includes the step of:
Keeping on pickup operation when both of the first and second vacuum circuits are detected a normal status, and keeping on pickup operation when at least one of the first and second vacuum circuits is detected abnormal, while triggering an alarm indicating the corresponding first or second vacuum circuit is abnormal.
